(19) United States
(12) Patent Application Publication
(10) Pub. No.: US 2014/0302918 A1
(43) Pub. Date: Oct. 9, 2014

(54) INTERACTIVE BETTING GAME

(71) Applicant: Gameblr Limited, Middlesex (GB)

(72) Inventor: Simon Solomon Minitzer, Tel Aviv (IL)

(73) Assignee: Gameblr Limited, Middlesex (GB)

(21) Appl. No.: 14/243,485

(22) Filed: Apr. 2, 2014

Related U.S. Application Data
(60) Provisional application No. 61/808,235, filed on Apr. 4, 2013.

(51) Int. Cl. G07F 17/32

(52) U.S. Cl. CPC G07F 17/3288
USPC 463/26

(57) ABSTRACT

A method for facilitating a betting game based on a selected non-instantaneous event, the method comprising using at least one hardware processor for: prior to the happening of a selected occurrence in the selected non-instantaneous event, associating each player of players of the betting game with a prediction with respect to the selected occurrence, wherein the players are unfamiliar with the selected occurrence; following the commencing of the selected non-instantaneous event, receiving one or more betting antes from the players and depositing the one or more betting antes in a virtual pot; in response to receiving a betting ante of the one or more betting antes from a betting player of the players, requesting each player of the players other than said betting player to deposit an ante matching the betting ante in the virtual pot; after the happening of the selected occurrence, and for each player of the players, determining if the player is a potential winner based on a comparison between the prediction associated with the player and corresponding datum of data with respect to the selected occurrence; and if at least one player of the players is determined as a potential winner, determining at least one potential winner as a winner, and rewarding the winner with at least some of the antes accumulated in the virtual pot.

### BACKGROUND

The present invention relates to the field of betting games.

Betting is the wagering of money or something of material value (referred to as “the stakes”) on an event with an uncertain outcome with the primary intent of winning additional money and/or material goods. Betting thus requires three elements be present: consideration, chance and prize. Typically, the outcome of the wager is evident within a short period.

Sports betting is the activity of predicting sports results and placing a wager on the outcome. A wide variety of sports betting games require the players to make a prediction of a specific outcome of a sporting event, and then wait until the event has completed to determine whether they won the bet. Another form of sports betting is, in-play betting, which enables the players to make a bet while the game is live.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method for facilitating a betting game based on a selected non-instantaneous event, the method comprising using at least one hardware processor for: prior to the happening of a selected occurrence in the selected non-instantaneous event, associating with each player of players of the betting game a prediction with respect to the selected occurrence, wherein the players are unfamiliar with the selected occurrence; following the commencing of the selected non-instantaneous event, receiving one or more betting antes from the players and depositing the one or more betting antes in a virtual pot; in response to receiving a betting ante of the one or more betting antes from a betting player of the players, requesting each player of the players other than said betting player to deposit an ante matching the betting ante in the virtual pot; after the happening of the selected occurrence, and for each player of the players, determining if the player is a potential winner based on a comparison between the prediction associated with the player and corresponding datum of data with respect to the selected occurrence; and if at least one player of the players is determined as a potential winner, determining at least one potential winner as a winner, and rewarding the winner with at least some of the antes accumulated in the virtual pot.

There is further provided, in accordance with an embodiment, a computer program product comprising a non-transitory computer-readable storage medium having program code embodied therewith, the program code executable by at least one hardware processor to: prior to the happening of a selected occurrence in a selected non-instantaneous event, associate each player of players of a betting game with a prediction with respect to the selected occurrence, wherein the players are unfamiliar with the selected occurrence; following the commencing of the selected non-instantaneous event, receive one or more betting antes from the players and deposit the one or more betting antes in a virtual pot; in response to receiving a betting ante of the one or more betting antes from a betting player of the players, request each player of the players other than said betting player to deposit an ante matching the betting ante in the virtual pot; after the happening of the selected occurrence, and for each player of the players, determine if the player is a potential winner based on a comparison between the prediction associated with the player and corresponding datum of data with respect to the selected occurrence; and if at least one player of the players is determined as a potential winner, determine at least one potential winner as a winner, and reward the winner with at least some of the antes accumulated in the virtual pot.

There is yet further provided, in accordance with an embodiment, a system comprising at least one server, the at least one server comprising: a non-transient storage medium; and at least one hardware processor configured to: prior to the happening of a selected occurrence in a selected non-instantaneous event, associate each player of players of a betting game with a prediction with respect to the selected occurrence, wherein the players are unfamiliar with the selected occurrence; record for each player of the players his associated prediction in said non-transient storage medium; following the commencing of the selected non-instantaneous event, receive one or more betting antes from the players and deposite the one or more betting antes in a virtual pot stored in the non-transient storage medium; in response to receiving a betting ante of the one or more betting antes from a betting player of the players, request each player of the players other than said betting player to deposit an ante matching the betting ante in the virtual pot; after the happening of the selected occurrence, and for each player of the players, determine if the player is a potential winner based on a comparison between the prediction associated with the player and corresponding datum of data with respect to the selected occurrence; and if at least one player of the players is determined as a potential winner, determine at least one potential winner, and reward the winner with at least some of the antes accumulated in the virtual pot.

In some embodiments, the method further comprises using said at least one hardware processor for receiving from each of the players an initial ante prior to the happening of the selected occurrence, and depositing each initial ante in the virtual pot.

In some embodiments, the method further comprises using said at least one hardware processor for receiving from a data provider: (i) a list of one or more non-instantaneous events monitored by said data provider, (ii) for each non-instantaneous event of said one or more non-instantaneous events, a list of one or more occurrences in the non-instantaneous event monitored by the data provider, and (iii) following the happening of each occurrence of the one or more occurrences of each non-instantaneous event of the one or more non-instantaneous events, data with respect to the occurrence, wherein said selected non-instantaneous event is selected from the list of one or more non-instantaneous events and said selected occurrence is selected from the list of one or more occurrences for the selected non-instantaneous event.

In some embodiments, the method further comprises using said at least one hardware processor for: selecting said selected non-instantaneous event from the list of one or more non-instantaneous events; and selecting said selected occurrence from the list of one or more occurrences in the selected non-instantaneous event.

In some embodiments, the associating with each player of players of the betting game the prediction with respect to the selected occurrence comprises associating with each player of the players of the betting game one or more predictions with respect to one or more selected occurrences in the selected non-instantaneous event.

In some embodiments, a player of said players joins the betting game after the commencing of the selected non-instantaneous event and prior to the happening of the selected occurrence.

In some embodiments, the associating with each player of the players a prediction with respect to the selected occurrence comprises randomly selecting a prediction with respect to the selected occurrence for each of the players, and wherein the randomly selected prediction for a player of said players is associated with said player.

In some embodiments, the associating with each player of the players a prediction with respect to the selected occurrence comprises receiving from each player of the players a prediction with respect to the selected occurrence, and wherein the prediction received from a player of said players is associated with said player.

In some embodiments, each prediction associated with a player of the players is revealed to each player of the players.

In some embodiments, each prediction associated with a player of said players is not revealed to players other than said player.

In some embodiments, the receiving of a betting ante of the one or more betting antes from a betting player of the players is performed after the happening of the selected occurrence in the event.

In some embodiments, a player of the players is determined as a potential winner if the result of the comparison provides that his associated prediction matches the corresponding datum.

In some embodiments, the method further comprises using said at least one hardware processor for associating each associated prediction with a time at which it was associated, wherein if more than one player of the players is determined as a potential winner, the determining of at least one potential winner as a winner comprises determining a potential winner, which is associated with a prediction associated with the earliest time with respect to each time associated with a prediction associated with a potential winner, as the winner of the betting game.

In some embodiments, only a player of the players associated with a prediction, which is the closest to the corresponding datum with respect to each prediction associated with a player of the players other than said player, is a potential winner.

In some embodiments, the method further comprises using said at least one hardware processor for: associating tie-breaker predictions with the players with respect to the selected occurrence, wherein each player of the players is associated with a tie-breaker prediction of the tie-breaker predictions, different from his associated prediction, wherein if more than one player of the players is a potential winner, the determining of a potential winner as a winner is based on the tie-breaker predictions.

In some embodiments, the method further comprises using said at least one hardware processor for depriving from winning the virtual pot each player of the players, who does not deposit an ante matching a betting ante of the one or more betting antes received from another player of the players, wherein the betting ante received from the another player was deposited in the virtual pot.

In some embodiments, the method further comprises using said at least one hardware processor for changing a prediction associated to a player of the players according to a request of the player and in exchange for depositing a penalty ante in the virtual pot.

In some embodiments, wherein a player of the players is out of ante, the method further comprises using said at least one hardware processor for: depriving the player from performing any further action in the frame of the betting game; generating a side virtual pot for the player; and transferring to the virtual side virtual pot the total of the antes accumulated in the virtual pot, current to the time of depriving of the player, wherein if the player is determined as a winner, the player is only rewarded from the ante accumulated in the side virtual pot.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a flowchart of a method for facilitating a betting game, constructed and operative in accordance with an embodiment of the disclosed technique; and

FIG. 2 shows a flowchart presenting exemplary courses of an exemplary betting game based on a sporting event.

### DETAILED DESCRIPTION

The methods, computer program products and systems disclosed herein may facilitate the playing of an interactive betting game (or simply “game”) with respect to a selected non-instantaneous event (hereinafter “event”), which may allow the players to interact with the game during the event.

A number of players may join the game. The players may bet over a selected occurrence in a selected non-instantaneous event, such as the first goal (i.e., the occurrence) in a live football game (i.e., the event). Optionally, each player may be required to deposit a predetermined initial ante to a virtual pot in order to enter the game. Optionally, in addition to making a prediction as to the selected occurrence (e.g., the first goal would take place at in 40th minute of the football game), each player may also makes a tie-breaker prediction in which he predicts an additional aspect of the selected occurrence (e.g., the first goal would be scored by player X) or predicts an aspect of another occurrence in the selected event (e.g., the minute in which the second goal would be scored). Thus, if multiple players make the same correct prediction with respect to the selected occurrence, the player who accurately predicts the tie-breaker prediction may be determined as the winner. Betting is typically made throughout the event, but may also take place before and following the event. The winner may take the virtual pot at the end of the game. The game may be over once the event is over or at a predetermined point in the event or following it. Additional features and elements of the betting game and its facilitation are described in greater detail herein below.

The term “non-instantaneous event”, as referred to herein, may relate to an event having a time duration, in which, one or more occurrences take place or are at least likely to take place.

The term “ante”, as referred to herein, may represent some value. Thus, the currency used for the ante may be actual money, cryptocurrency, social currency, gaming points (e.g., embodied as virtual chips), or any other virtual or real objects, or any combination thereof.

The term “virtual pot”, as referred to herein, may relate to a data set representing the antes deposited by (or received from) the players in a betting game with respect to a specific type of prediction relating to a specific occurrence in a non-instantaneous event. By “antes” it is meant any type of antes indicated herein below, including, initial antes, betting antes and penalty antes.

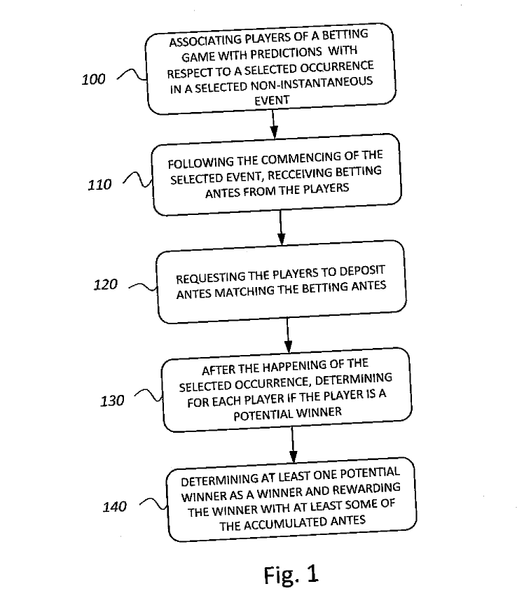

Reference is now made to FIG. 1 which shows a flowchart of a method for facilitating a betting game, constructed and operative in accordance with an embodiment of the disclosed technique. The method may be embodied as software, which, for example, may interact with the players using a website hosted on a server or may be an application (e.g., a software application for a mobile electronic device) which may connect with such a server. The website or mobile application and/or the server may serve as the “house” of the betting game. The “house” may handle multiple betting games simultaneously and following that, players may join and participate in multiple betting games simultaneously.

In a step 100, players of the betting game may be each associated with a prediction with respect to a selected occurrence in a selected non-instantaneous event. The prediction association may be performed prior to the happening of the selected occurrence. The players are unfamiliar with the selected occurrence.

The selected non-instantaneous event may be, for example, a sporting event, a board game play, a competition or a movie. Furthermore, the non-instantaneous event may be, for example, a live event (i.e., currently happening), such as a live sporting event, or a recording of an event which had already happened, such as a recording of a sporting event. The selected occurrence in the event may be, for example, scoring a first goal in a football game, a certain time in the football game, a first kiss between the lead actors in a movie or the end of a sporting event. A prediction with respect to a selected occurrence may be, for example, the minute in the football game at which the goal was scored or the name of the player which scored the goal, the score in the certain time in the game, the minute or a time range in the movie in which the first kiss took place, the score or the winner at the end of the sporting event.

The betting game may be initiated for two or more players. The number of players may be limited prior to commencement of the game, or alternatively, may be defined as unlimited. Optionally, recommendations may be provided as to the preferred maximum number of players in a game, based on factors such as the nature of the event on which the players will bet etc.

In some embodiments, players may join the game only prior to the commencing of the game. In some embodiment, players may join the game at any time prior to the happening of the selected occurrence at which the players bet. In some embodiments, players may join the betting game only prior to the commencing of the selected event. In some embodiment, players may join the game after the commencing of the selected events and prior to the happening of the selected occurrence.

If the selected event is a live event, it may be streamed via a live feed to the house. If the selected event is a recording of some live event, or a movie, it may be displayed to the players by the house. Optionally, a link to a website may be provided, at which the players may view the selected event. Additionally or alternatively, the selected event may be viewed on a different medium such as a TV.

In some embodiments, a data provider monitoring non-instantaneous event may be used (e.g., Enetpulse, http://www.enetpulse.com) for receiving data with respect to the events and occurrences in the events. Thus, in an optional step, a list of one or more non-instantaneous events monitored by the data provider may be received from the data provider. Furthermore, for each non-instantaneous event, a list of one or more occurrences in the non-instantaneous even, which are monitored by the data provider, may be also received. Thus, each selected event may be selected from the list of the non-instantaneous events and each selected occurrence may be selected from the list of occurrences in the selected non-instantaneous events.

Thus, in an optional step, the selected non-instantaneous event may be selected from the list of the one or more non-instantaneous events and/or the selected occurrence may be selected from the list of the one or more occurrences for the selected event. Optionally a selected event and/or a selected occurrence for a betting game may be selected by a player, e.g., the player which initiates the betting game.

Alternatively, the method may include an optional step at which monitoring of one or more non-instantaneous events and of one or more occurrences in the one or more non-instantaneous events may be performed. The monitoring may include recording data referring to the events and the occurrences with respect to predefined predictions. For example, if a predefined prediction with respect to an end of game occurrence of a sporting event is a score, then such score would be recorded. If a monitored event is a live event, then the monitoring of this event may be performed in real-time.

In an optional step, players may be registered. The registration may be performed, for example, by the house (e.g., a website). Optionally, registration with the house may be required in order to play a game. Registration may be accomplished over the internet through a desktop browser, laptop, smartphone application, tablet, smart TV, TV or any other suitable means. A server may maintain a database of registered players, including at least some of the following data: usernames and passwords, a public and private profile of each player, as well as payment information, such as credit card details for each player, all of which are input by the player during the registration process. Furthermore, player history, such as win-loss statistics, types of games played, etc. may be stored as well in the database for players to follow their performance. In some embodiments, players may receive prizes or bonus points for increasing the number of games played and/or games won.

In an optional step, a player may be required to log in to the house in order to join a game. A player may log in by entering a correct username (e.g., his phone number) and password. In some embodiments, in which the house is embodied as a website, a player may browse the website but only access certain areas, while other areas require logging in, for instance, via a username and password.

In an optional step, a betting game may be initiated. The initiation may be performed automatically, for example, in a predefined time prior to the commencing of the selected event or upon commencing of the selected event, or upon a request of a player. In some embodiments, the game may initiate automatically as long as a minimum of two players or any other predetermined number of players had already joined the game. If the event is a live event, the house may indicate the time remaining of the live event.

A player who initiates a game is referred to herein as the game initiator. In an optional step, links and instructions for a player of how to initiate a game may be provided. In order to initiate a game, a player may enter the house and follow the links and instructions of how to initiate a game. Any registered player may be able to initiate a game. All additional players may join the game in order to play. The game initiator may have the ability to cancel the game at any time prior to the commencing of the selected event.

A betting game may include fixed rules and variable rules. In some embodiments, all of the rules may be set by the house. In an optional step, a set of fixed ruled may be set for the betting game. The fixed rules may be conditions set by the house that are necessary to fulfill in order to participate in a game, and may include but are not limited to, a requirement for each player to provide a prediction with respect to the selected occurrence in the event. Optionally, the fixed rules may include a requirement for each player to deposit an initial ante to a virtual pot, and/or a requirement for each player to provide a tie-breaker prediction. The above mentioned requirements would be further described herein below.

In an optional step, a set of variable rules may be set for the betting game. The variable rules may be set automatically, by the house, e.g., to default values. Alternatively, the set of variable rules may be set by the game initiator, and may include but are not limited to the number of players allowed in the game, the amount of currency for the initial ante, the minimum and/or maximum amounts of betting antes that may be placed by the players throughout the game, the particular event on which to bet, the type of currency to be used, the number of predictions players may make during a selected event (i.e., each bet with respect to a different occurrence in the event), limits as to the times throughout the event at which betting may be made, whether the game will be “closed” or “open”, etc. Alternatively, a different player or players may set the variable rules. Optionally, the variable rules may be set as “no restrictions”, whereby the aforementioned variable rules allow for unlimited number of players, bets, amounts, etc. Alternatively, the variable rules may be set as a combination of restrictions and no restrictions. The game initiator may be presented with a complete list of variable rules for him to set prior to the initiation of the game. All players may be informed of the set of variable rules prior to joining the game.

A game may allow betting with respect to more than one prediction type and/or more than one occurrence in the event. In such a game, more than one prediction may be associated with each player, and therefore the game may include more than one virtual pot (i.e., a multi-pot game). In such a multi-pot game, a player may participate in one or more virtual pots according to his choice. In some embodiments, a player of a multi-pot game may be required to participate in all of the virtual pots in the game. Furthermore, more than one game may be played with respect to an event or an occurrence in the event. Such options may be set as part of the fixed rules or the variable rules.

In some embodiments, the betting game may be an “open” game (or “public” game). An “open” game is defined herein as a game that is open to any registered or registered and unregistered players to join as players in the game. Optionally, in order to view available open games in a website house, one may browse the website without logging in. Optionally, one may be required to login in order to view available open games.

In some embodiments, the betting game may be a “closed” game (or a “private” game). A “closed” game is defined herein as a game in which a player, typically the initiator of the game, may determine who may join the game. For example, in an optional step, one or more invitations may be issued in order to join the game upon request of the game initiator. Invitations may be sent by email, in application push notification, in-app message, SMS, or any other suitable electronic or non-electronic means. If the number of players is defined as a limited number, the first players to join the game and reach the limited number are accepted and no further players may join, even if the number of invitations issued exceeds the maximum limit of number of players. Typically, some or all of the players in a closed game would be acquainted with each other, either in the real world or in the virtual/online world. The receiver of an invitation may accept the invitation in order to participate in a closed game. This may be performed by accessing the house website via, for instance, one of the methods mentioned herein above or by installing the house application. If the invitation is rejected or ignored, the receiver of the invitation may not be able to join the game.

In an optional step, an initial ante may be received from each of the players prior to the happening of the selected occurrence. The initial ante may be deposited in the virtual pot. The initial ante may be required in order to participate in a game.

In some embodiments, the associating with a player of the players a prediction with respect to the selected occurrence may include randomly selecting a prediction with respect to the selected occurrence. In some embodiments, the associating with a player of the players a prediction with respect to the selected occurrence may include receiving from the player such a prediction. Each player's randomly selected or received prediction may be then associated with the player. The type of prediction with respect to a selected occurrence in a selected event that may be provided by each player may be determined according to the nature of the selected event and the selected occurrence on which the players are betting. The type of predictions may be predefined. For example, if the selected event is a football game and the selected occurrence is the first scored goal, then the predefined types of predictions may be the game minute at which the goal was scored or the name of the player who scored. The type of prediction with respect to a selected occurrence may be determined by the house or by a player, such as the first player to select a prediction or the game initiator. Following the determination of the type of prediction, a prediction may be associated with each player. Referring to the above example, the determined type of prediction may be the game minute. Thus, a game minute may be randomly associated with players, such as 25 or 30, or a player may input such minute.

In some embodiments, once a prediction with respect to a selected occurrence is associated with a player, it may not be changed. In some embodiments, a prediction associated with a player may be changed according to a request of the player and in exchange for depositing a penalty ante in the virtual pot. The option to change prediction may be set in the variable rules. Such option may be unlimited (i.e., changes may be made multiple times) or limited to a specific number of changes allowed.

A player would typically desire to change his specific prediction if it becomes clear to him that his prediction is or will be incorrect. This may occur if, for instance, the current score of a game event has surpassed the final score prediction (if that is the specific prediction type), if a star player on the team that he predicted to win becomes injured, etc.

In some embodiments, the game may be an “open pot” game. An “open pot” game will be defined herein as a game at which each prediction associated with a player may be revealed to each of the other players. In some embodiments, the game may be a “closed pot” game (or a “blind” game). A “closed pot” game will be defined herein as a game at which each prediction associated with a player of said players is not revealed to the other players. The “open pot” or “closed pot” definitions, as described herein above with respect to the betting game, may also relate correspondingly to a specific virtual pot in a multi-pot game, i.e., an “open” pot or a “closed” (or “blind”) pot. Thus “open” pot or “closed” pot may relate only to a specific prediction type with respect to a specific occurrence in the event. For example, a specific pot in which antes are deposited with respect to a specific prediction in a betting game may be defined as “open”. Another pot in which antes are deposited with respect to a different prediction in the betting game may be defined as “closed”.

Thus, in a “closed pot” game each player's predictions may be known only to him and may not be disclosed by the house to any of the other players. Similarly, if a player changes his specific prediction, the fact that he changes his prediction may not be disclosed to the other players. In some embodiments, specific prediction changes may be disclosed to all players, while the prediction itself remains undisclosed.

In a step 110, following the commencing of the selected event, one or more betting antes may be received from the players and may be deposited in the virtual pot. Each player may place one or more betting antes.

In a step 120, in response to receiving a betting ante from a betting player, each player of the other players may be requested to deposit an ante matching the betting ante in the virtual pot. Each player who does not deposit an ante matching a betting ante received from another player (i.e., the betting player) and deposited in the virtual pot may be deprived from winning the virtual pot and/or the game. If the betting game includes only one virtual pot, then the player may not win the game. If the game is a multi-pot game, then the player may be deprived from only winning the virtual pot to which the betting ante was deposited. Such player may be further deprived from performing any other action with respect to the prediction which the received betting ante relates to.

Thus, the betting process throughout the game may include one of the following poker-like operations: betting by raising the amount in the virtual pot (i.e., depositing a betting ante), calling another player's bet (i.e., matching a betting ante deposited by another player) and folding. Raising the amount in the virtual pot when calling another player's bet may be referred as re-raising. Betting may take place throughout the game, whereby a player may raise the ante by adding additional currency amounts to the virtual pot (i.e., depositing a betting ante to the virtual pot). Typically, a player would raise the ante when his certainty in his prediction increases. Alternatively, a player may bluff by raising the ante although his prediction may be inaccurate. The players may be restricted to maximum and/or minimum amounts of betting antes and may be restricted from betting on their entire ante (i.e., go all in). The players may be restricted to a certain number of times they may be allowed to raise the ante (i.e., the number of times they may deposit a betting ante in the virtual pot). In some embodiments, raising the ante may be unrestricted. The running total of the current amount of the virtual pot may be displayed to all players throughout the game.

When a player makes a bet, all other players may be notified of the amount of the bet as well as which player made the bet. In some embodiments, a time limit may be set for other players to respond by calling, raising or folding. Push notifications and/or sound alerts may be sent to players while time remains. The time limit may be a variable rule that may be set before the game initiates. Hence, if the time expires, the players will automatically call or fold, depending on the variable rules settings. Optionally, each player may set his own action, e.g. call or fold, for when the time expires.

The betting antes may be received at any time following the commencing of the selected event. In some embodiments, typically in “closed pot” games (or “closed” pots), betting antes may be received from players after the happening of the selected occurrence. In some embodiments, betting antes may be also received prior to the commencing of the event and once the game is initiated.

If two players respond simultaneously, whereby one player calls and another player raises, the player who called may then be required to call, raise or fold based on the action of the other player. Thus, betting may be performed in a predetermined sequence of players so that simultaneous betting will not occur.

In an optional step, a player which is out of ante may be deprived from performing any further action in the frame of the betting game, such as bet, call or raise. A side virtual pot may be generated for the player. The total ante in the virtual pot current to the time of depriving of the player may be transferred to the side virtual pot. If the deprived player is determined as a winner of the betting game (in a single pot game) or the virtual pot (in a multi-pot game), he may only be rewarded from the total ante in the side virtual pot. If another player is determined as a winner of the betting game or of the virtual pot, he may be rewarded from both the total ante in the virtual pot and the side virtual pot. If such another player changed his prediction to the correct prediction (e.g., matching the prediction of the deprived player) after the deprived player was deprived, then he may only be rewarded from the total ante in the virtual pot (i.e., not from the side virtual pot).

In a step 130, after the happening of the selected occurrence in the selected non-instantaneous event, and for each player of the players, determining if the player is a potential winner of the virtual pot and/or the betting game (or simply “the winner”) may be performed. The determination may be based on a comparison between the prediction associated with the player and corresponding datum of data with respect to the selected occurrence.

In some embodiments, the data provider may be further used for receiving the data with respect to the selected occurrence following the happening of the occurrence. The data may be received via an XML feed and updated on the server. Such a step may be typically applied when live events are concerned. Referring back to the above example, following the scoring of the first goal, an XML feed may be received from the data provider including data, which includes the minute in the game at which the goal was scored (i.e., a first datum) and the name of the scorer (i.e., a second datum). If the prediction type of the players is the game minute then the corresponding datum to be compared with the player's predictions is the first datum of the received data.

In some embodiments, a player may be determined as a potential winner if the result of the comparison provides that his associated prediction matches the corresponding datum. In such embodiments, more than one player may be determined as a potential winner and none of the players may be determined as a potential winner. In some embodiments, the player associated with a prediction, which is the closest to the corresponding datum with respect to the other predictions associated with other players, may be a potential winner. In such embodiments, only one player may be determined as a potential winner and there will always be such a player.

In a step 140, if at least one player is determined as a potential winner, at least one potential winner may be determined as a winner of the virtual pot and/or betting game. The winner (or winners) of the virtual pot and/or betting game may be rewarded with at least some of the antes accumulated in the virtual pot. In some embodiments, the winner may be rewarded with the total of the antes accumulated in the virtual pot. If the betting game includes only one virtual pot (i.e., only one prediction per each player), then the winner of the virtual pot may be also the winner of the betting game. In a multi-pot game, multiple winners may be determined (e.g., each per a virtual pot), or a single winner may be determined. Optionally, in a multi-pot game, each winner of a virtual pot may be determined as a potential winner.

If multiple potential winners are established, they may be ranked (e.g., according to further one or more criterions, as will be detailed herein below) and determined, for example as first (i.e., the winner), second and third places. In some embodiments, the second and third places, or further places, may be also rewarded with a specific share of the virtual pot. If multiple winners are established for a certain virtual pot, then they may split the antes in the virtual pot. If no winners are established for a certain virtual pot, then the players may split the virtual pot.

In an optional step, each prediction associated with a player may be further associated with the time at which it was associated with the player. Thus, if more than one player is determined as a potential winner, the determining of the winner may include determining the potential winner, which is associated with the prediction that is associated with the earliest time, as the winner. Therefore, the player which was chronologically the first to make the accurate prediction may be the winner. For example, if player A makes a correct prediction prior to the commencing of a live sporting event, and player B makes the correct prediction by revising his initial prediction at any point after the live sporting event commenced, then player A may be the winner.

In an optional step, tie breaker predictions with respect to the selected occurrence may be associated with the players. Each player may be associated with a tie breaker prediction which is different from his initial associated prediction. If more than one player is a potential winner, the determining of a potential winner as a winner may be based on the tie breaker predictions.

Thus, if multiple players make accurate predictions at the same time, for instance, prior to the commencement of the selected event, then the tie-breaker prediction may determine who the winner is. For example, if predictions are made as to the time during a football game at which the first goal is scored, then the tie-breaker prediction may be the time during the game at which the second goal is scored. Hence, the player who accurately predicted the tie-breaker prediction, for instance, the time in the game at which the first point is scored, may be the winner. Alternatively, the player whose tie-breaker prediction comes closest to being correct may be the winner. In some embodiments, additional or alternative tie-breaker predictions may be established. If all predictions are tied, the virtual pot may be split amongst the players who made the same winning predictions.

If a player changes his prediction at some time during the game, the time in the game in which the new prediction is made becomes the new prediction time of the player. Thus, if player A makes the same prediction as player B, but player A has an earlier prediction time, then player A will win the game. In some embodiments, once a player changes his specific prediction he may not be able to revert back to an earlier prediction time even if he then changes his prediction to the same prediction from an earlier prediction time. In one embodiment, the tie-breaker prediction may not be changed during the game. In alternative embodiments, the tie-breaker prediction may be changed during the game.

In some embodiments, if all players fold except for one prior to the happening of the selected occurrence, the one player which did not fold may be determined as the winner. Alternatively, the players may choose to restart the game while the selected event is still in play. The original tie-breaker predictions may remain in effect.

In a multi-pot game, a winner of each pot may be determined and/or a winner of the multi-pot game. The winner of the game may be, for example, the player who won the most virtual pots in the game. The winner of the game may be rewarded, for example, with a certain share of the antes accumulated in each virtual pot in the game.

The method of payment of the virtual pot to the winner may be determined based on the type of currency used to bet. For instance, if real money was used to bet, then a payment may be transferred to the winner's bank account or added to his credit. If social currency or gaming points are used to bet, then the appropriate amount of currency may be transferred to the winner's account.

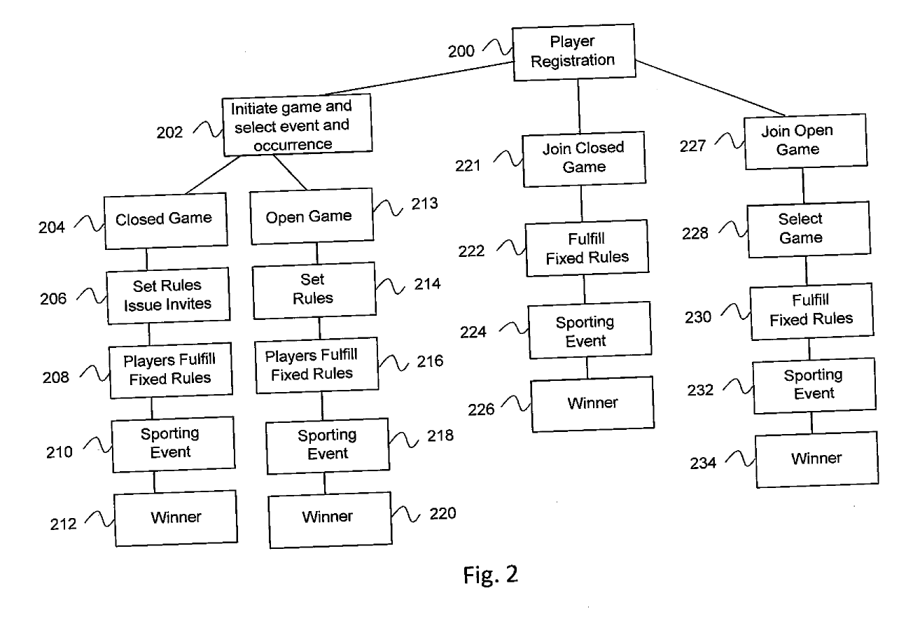

FIG. 2 shows a flowchart presenting exemplary courses of an exemplary betting game based on a sporting event. In step (200) a player may enter the house (e.g., a website or an application) and registers. If already registered, the player may log in using, for instance, a username and password. The player has one of following options: initiate a game, join a closed game or join an open game. In step (202) the player may choose to initiate a game. The player may further select the event, for example, a live sporting event, and an occurrence in the event on which bets would be made. In addition, the player may select the type of predictions that would be made with respect to the selected occurrence. The player may select from one of the following options: closed game and open game. In step (204) the player may choose to initiate a closed game. In step (206) the player may set the variable rules of the game and issue invitations to other players. In step (208) the other players who accept the invitations fulfill the fixed rules by, for example, depositing an initial ante, making a prediction and making a tie-breaker prediction. In step (210) the live sporting event commences and bets may be made throughout the sporting event. In step (212) a winner may be determined, if necessary via a tie-breaker prediction.

If, instead of choosing to initiate a closed game the player chooses, in step (213) to initiate an open game, then in step (214) the player may set the variable rules and may wait until other players join the game. In step (216) other players may join the game by fulfilling the fixed rules, as described above. In step (218) the live sporting event commences and bets may be made throughout the sporting event. In step (220) a winner may be determined, if necessary via a tie-breaker prediction.

If, instead of choosing to initiate a game, the player chooses, in step (221) to join a closed game based on a live sporting event, then in step (222) the player may accept an invitation and may fulfill the fixed rules, as described above. In step (224) the live sporting event commences and bets may be made throughout the sporting event. In step (226) a winner may be determined, if necessary via a tie-breaker prediction.

If, instead of choosing to initiate a game or join a closed game the player chooses, in step (227) to join an open game, then in step (228) the player may select the open game that he wants to join, for example, an open game based on a live sporting event, and in step (230) the player may fulfill the fixed rules, as described above. In step (232) the live sporting event commences and bets may be made throughout the sporting event. In step (234) a winner may be determined, if necessary via a tie-breaker prediction.

A system operating according to the above disclosed methods is herein disclosed. The system may include at least one server. A server of the system may include a non-transient storage medium and at least one hardware processor. The non-transient storage medium may be used to store information such as the players registration, profile and history data, the predictions associated with the different players, the virtual pot and records of ante payments, the data received from the data provider, etc.

In some embodiments, the betting game may be a multi-event game. A multi-event game may allow placing bets with respect to multiple events. A player in such a game may be required to place bets with respect to all of the events or with respect to at least one event, optionally according to his choice (i.e., a player may choose which events to bet on).

Although some sections of the description may relate to a betting game which includes associating a single prediction to each player of the game (i.e., a game including only one virtual pot), the methods, systems and computer program products as described herein also relate to embodiments of a multi-pot games, when each player is associated with more than one prediction with respect to a selected event, with the required modifications.

In some embodiments, the game may be played by players who communicate electronically through an online network, such as the internet, an intranet or other suitable networking system. In alternative embodiments, the game may be played offline, mutatis mutandis, whereby players communicate, for instance, verbally.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for facilitating a betting game based on a selected non-instantaneous event, the method comprising using at least one hardware processor for:
prior to the happening of a selected occurrence in the selected non-instantaneous event, associating with each player of players of the betting game a prediction with respect to the selected occurrence, wherein the players are unfamiliar with the selected occurrence;
following the commencing of the selected non-instantaneous event, receiving one or more betting antes from the players and depositing the one or more betting antes in a virtual pot;
in response to receiving a betting ante of the one or more betting antes from a betting player of the players, requesting each player of the players other than said betting player to deposit an ante matching the betting ante in the virtual pot;
after the happening of the selected occurrence, and for each player of the players, determining if the player is a potential winner based on a comparison between the prediction associated with the player and corresponding datum of data with respect to the selected occurrence; and
if at least one player of the players is determined as a potential winner, determining at least one potential winner as a winner, and rewarding the winner with at least some of the antes accumulated in the virtual pot.

2. The method of claim 1, further comprising using said at least one hardware processor for receiving from each of the players an initial ante prior to the happening of the selected occurrence, and depositing each initial ante in the virtual pot.

3. The method of claim 1, further comprising using said at least one hardware processor for receiving from a data provider:
(i) a list of one or more non-instantaneous events monitored by said data provider,
(ii) for each non-instantaneous event of said one or more non-instantaneous events, a list of one or more occurrences in the non-instantaneous event monitored by the data provider, and
(iii) following the happening of each occurrence of the one or more occurrences of each non-instantaneous event of the one or more non-instantaneous events, data with respect to the occurrence,
wherein said selected non-instantaneous event is selected from the list of one or more non-instantaneous events and said selected occurrence is selected from the list of one or more occurrences for the selected non-instantaneous event.

4. The method of claim 3, further comprising using said at least one hardware processor for:
selecting said selected non-instantaneous event from the list of one or more non-instantaneous events; and
selecting said selected occurrence from the list of one or more occurrences in the selected non-instantaneous event.

5. The method of claim 1, wherein the associating with each player of players of the betting game the prediction with respect to the selected occurrence comprises associating with each player of the players of the betting game one or more predictions with respect to one or more selected occurrences in the selected non-instantaneous event.

6. The method of claim 1, wherein a player of said players joins the betting game after the commencing of the selected non-instantaneous event and prior to the happening of the selected occurrence.

7. The method of claim 1, wherein the associating with each player of the players a prediction with respect to the selected occurrence comprises randomly selecting a prediction with respect to the selected occurrence for each of the players, and wherein the randomly selected prediction for a player of said players is associated with said player.

8. The method of claim 1, wherein the associating with each player of the players a prediction with respect to the selected occurrence comprises receiving from each player of the players a prediction with respect to the selected occurrence, and wherein the prediction received from a player of said players is associated with said player.

9. The method of claim 1, wherein each prediction associated with a player of the players is revealed to each player of the players.

10. The method of claim 1, wherein each prediction associated with a player of said players is not revealed to players other than said player.

11. The method of claim 10, wherein the receiving of a betting ante of the one or more betting antes from a betting player of the players is performed after the happening of the selected occurrence in the event.

12. The method of claim 1, wherein a player of the players is determined as a potential winner if the result of the comparison provides that his associated prediction matches the corresponding datum.

13. The method of claim 10, further comprising using said at least one hardware processor for associating each associated prediction with a time at which it was associated, wherein if more than one player of the players is determined as a potential winner, the determining of at least one potential winner as a winner comprises determining a potential winner, which is associated with a prediction associated with the earliest time with respect to each time associated with a prediction associated with a potential winner, as the winner of the betting game.

14. The method of claim 1, wherein only a player of the players associated with a prediction, which is the closest to the corresponding datum with respect to each prediction associated with a player of the players other than said player, is a potential winner.

15. The method of claim 1, further comprising using said at least one hardware processor for:
associating tie-breaker predictions with the players with respect to the selected occurrence, wherein each player of the players is associated with a tie-breaker prediction of the tie-breaker predictions, different from his associated prediction,
wherein if more than one player of the players is a potential winner, the determining of a potential winner as a winner is based on the tie-breaker predictions.

16. The method of claim 1, further comprising using said at least one hardware processor for depriving from winning the virtual pot each player of the players, who does not deposit an ante matching a betting ante of the one or more betting antes received from another player of the players, wherein the betting ante received from the another player was deposited in the virtual pot.

17. The method of claim 1, further comprising using said at least one hardware processor for changing a prediction associated to a player of the players according to a request of the player and in exchange for depositing a penalty ante in the virtual pot.

18. The method of claim 1, wherein a player of the players is out of ante, further comprising using said at least one hardware processor for:
depriving the player from performing any further action in the frame of the betting game;
generating a side virtual pot for the player; and
transferring to the virtual side virtual pot the total of the antes accumulated in the virtual pot, current to the time of depriving of the player,
wherein if the player is determined as a winner, the player is only rewarded from the ante accumulated in the side virtual pot.

19. A computer program product comprising a non-transitory computer-readable storage medium having program code embodied therewith, the program code executable by at least one hardware processor to:
prior to the happening of a selected occurrence in a selected non-instantaneous event, associate each player of players of a betting game with a prediction with respect to the selected occurrence, wherein the players are unfamiliar with the selected occurrence;
following the commencing of the selected non-instantaneous event, receive one or more betting antes from the players and deposit the one or more betting antes in a virtual pot;
in response to receiving a betting ante of the one or more betting antes from a betting player of the players, request each player of the players other than said betting player to deposit an ante matching the betting ante in the virtual pot;
after the happening of the selected occurrence, and for each player of the players, determine if the player is a potential winner based on a comparison between the prediction associated with the player and corresponding datum of data with respect to the selected occurrence; and
if at least one player of the players is determined as a potential winner, determine at least one potential winner as a winner, and reward the winner with at least some of the antes accumulated in the virtual pot.

20. A system comprising at least one server, the at least one server comprising:
a non-transient storage medium; and
at least one hardware processor configured to:
prior to the happening of a selected occurrence in a selected non-instantaneous event, associate each player of players of a betting game with a prediction with respect to the selected occurrence, wherein the players are unfamiliar with the selected occurrence;
record for each player of the players his associated prediction in said non-transient storage medium;
following the commencing of the selected non-instantaneous event, receive one or more betting antes from the players and deposite the one or more betting antes in a virtual pot stored in the non-transient storage medium;
in response to receiving a betting ante of the one or more betting antes from a betting player of the players, request each player of the players other than said betting player to deposit an ante matching the betting ante in the virtual pot;
after the happening of the selected occurrence, and for each player of the players, determine if the player is a potential winner based on a comparison between the prediction associated with the player and corresponding datum of data with respect to the selected occurrence; and
if at least one player of the players is determined as a potential winner, determine at least one potential winner, and reward the winner with at least some of the antes accumulated in the virtual pot.
